(19) United States
(12) Patent Application Publication
(10) Pub. No.: US 2025/0355751 A1
(43) Pub. Date: Nov. 20, 2025

(54) ONLINE MULTI-MODALITY ROOT CAUSE ANALYSIS

(71) Applicant: NEC Laboratories America, Inc., Princeton, NJ (US)

(72) Inventors: Zhengzhang Chen, Princeton Junction, NJ (US); Haifeng Chen, West Windsor, NJ (US); Lecheng Zheng, Monmouth Junction, NJ (US)

(21) Appl. No.: 19/202,181

(22) Filed: May 8, 2025

Related U.S. Application Data
(60) Provisional application No. 63/647,130, filed on May 14, 2024.
(60) Provisional application No. 63/649,720, filed on May 20, 2024.

(51) Int. Cl. G06F 11/07

(52) U.S. Cl. CPC G06F 11/079; G06F 11/0709

(57) ABSTRACT

Systems and methods for online multi-modality root cause analysis. A root cause of a detected system fault can be identified based on a fused causal graph that represents the relationship of the factors and correlation of multi-modality data by, determining long-term temporal dependencies and causal relation from system entities and key performance indicators (KPI) of a cloud computing system using dilated convolutional neural networks, analyzing a correlation of factors from multi-modality data to assess contributions of the factors to causing a detected system fault, and learning a relationship of the factors and correlation of multi-modality data with contrastive representation learning. System maintenance that corrects the detected system fault caused by the root cause can be performed autonomously.

### RELATED APPLICATION INFORMATION

This application claims priority to U.S. Provisional App. No. 63/647,130, filed on May 14, 2024; and U.S. Provisional App. No. 63/649,720, filed on May 20, 2024; incorporated herein by reference in their entirety.

### BACKGROUND

### Technical Field

The present invention relates to artificial intelligence for information technology operations (AIOPs) for distributed computing environments, and more particularly to online multi-modality root cause analysis.

### Description of the Related Art

Current cloud systems interconnect numerous computing nodes to provide robust, scalable, online workflow processes. Because of the large number of computing nodes and processes generated, distributed computing environments such as cloud systems can produce enormous amounts of data. Such data could be used to determine the status of a cloud system. However, finding a vulnerability within the cloud system using such data would be a difficult task due to the immense scale of cloud systems that requires a significant amount of time and resources to identify, solve, and prevent issues caused by the vulnerability.

### SUMMARY

According to an aspect of the present invention, a computer-implemented method is provided for online multi-modality root cause analysis, including, identifying a root cause of a detected system fault based on a fused causal graph that represents a relationship of factors and correlation of multi-modality data by, determining long-term temporal dependencies and causal relation from system entities and key performance indicators (KPI) of a cloud computing system using dilated convolutional neural networks, analyzing a correlation of factors from multi-modality data to assess contributions of the factors to causing a detected system fault, and learning a relationship of the factors and correlation of multi-modality data with contrastive representation learning, and performing system maintenance autonomously that corrects the detected system fault caused by the root cause.

According to another aspect of the present invention, a system is provided for online multi-modality root cause analysis, including, a memory device, and one or more processor devices operatively coupled with the memory device to, identify a root cause of a detected system fault based on a fused causal graph that represents a relationship of factors and correlation of multi-modality data by, determining long-term temporal dependencies and causal relation from system entities and key performance indicators (KPI) of a cloud computing system using dilated convolutional neural networks, analyzing a correlation of factors from multi-modality data to assess contributions of the factors to causing a detected system fault, and learning a relationship of the factors and correlation of multi-modality data with contrastive representation learning, and perform system maintenance autonomously that corrects the detected system fault caused by the root cause.

According to another aspect of the present invention, a non-transitory computer program product is provided including a computer-readable storage medium including program code for online multi-modality root cause analysis, wherein the program code when executed on a computer causes the computer to, identify a root cause of a detected system fault based on a fused causal graph that represents a relationship of factors and correlation of multi-modality data by, determining long-term temporal dependencies and causal relation from system entities and key performance indicators (KPI) of a cloud computing system using dilated convolutional neural networks, analyzing a correlation of factors from multi-modality data to assess contributions of the factors to causing a detected system fault, and learning a relationship of the factors and correlation of multi-modality data with contrastive representation learning, and perform system maintenance autonomously that corrects the detected system fault caused by the root cause.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a method for online multi-modality root cause analysis, in accordance with an embodiment of the present invention;

FIG. 2 is a block diagram illustrating a cloud intelligent system architecture for online multi-modality root cause analysis, in accordance with an embodiment of the present invention;

FIG. 3 is a block diagram illustrating software and hardware components of the online root cause analysis module, in accordance with an embodiment of the present invention;

FIG. 4 is a block diagram illustrating a system for online multi-modality root cause analysis, in accordance with an embodiment of the present invention; and

FIG. 5 is a block diagram showing a structure of deep neural networks for online multi-modality root cause analysis, in accordance with an embodiment of the present invention.

### DETAILED DESCRIPTION OF PREFERRED EMBODIMENTS

In accordance with embodiments of the present invention, systems and methods are provided for online multi-modality root cause analysis.

In an embodiment, a root cause of a detected system fault can be identified based on a fused causal graph that represents the relationship of the factors and correlation of multi-modality data by: determining long-term temporal dependencies and causal relation from system entities and key performance indicators (KPI) of a cloud computing system using dilated convolutional neural networks, analyzing a correlation of factors from multi-modality data to assess contributions of the factors to causing a detected system fault, and learning a relationship of the factors and correlation of multi-modality data with contrastive representation learning. System maintenance that corrects the detected system fault caused by the root cause can be performed autonomously.

Root Cause Analysis (RCA) can identify the origins of system failures in microservice systems which can severely impact user experience and lead to substantial financial losses. To ensure the reliability and robustness of microservice systems, key performance indicators (KPIs) like latency, metrics data such as CPU/memory usage, and log data including pod-level Kubernetes™ entries are often collected and analyzed. However, the complexity of these systems combined with the vast amount of monitoring data can make manual root cause analysis both costly and error-prone, let alone root cause analysis in an online manner.

Previous RCA works have focused primarily on developing effective offline methods for root cause localization. However, these methods rely solely on data from a single modality, thus failing to capture the intricacies of various abnormal patterns associated with system failures. Some system failures, such as Database Query Failures or Login Failures, can elude detection if system logs are not harnessed to pinpoint their root causes. Conversely, system metrics and logs collectively contribute to the localization of system faults like “Disk Space Full”.

The present invention addresses the issues of monitoring and identifying the root causes of the failure/fault events in cloud systems including physical equipment, virtualized nodes and functions, operating systems, and applications in an online multi-modal fashion.

Current auto-regressive based RCA approaches can only capture the temporal dependency in a short time period. However, some abnormal patterns (e.g., Distributed Denial of Service (DDOS) attacks) may last for a long time. The present embodiments can capture this long-term temporal dependency.

Existing online approaches tend to uncover the abnormal patterns from multiple factors (e.g., CPU usage, memory usage for system metrics) individually while ignoring the potential relationship among different factors. In addition, the existing approaches treat these factors with equal importance, however, some factors may be more important than others. The present embodiments can re-assess the contribution of each factor to the causal structure learning and capture the correlation of the multi-dimensional factors.

In microservice platforms, system faults can occur frequently. Retraining existing offline multi-modal RCA approaches to detect system failures every time can be time-consuming and expensive. Finetuning these multi-modal RCA approaches could also result in forgetting the abnormal patterns captured in the past. The present embodiments address these issues with online learning of multi-modality representations.

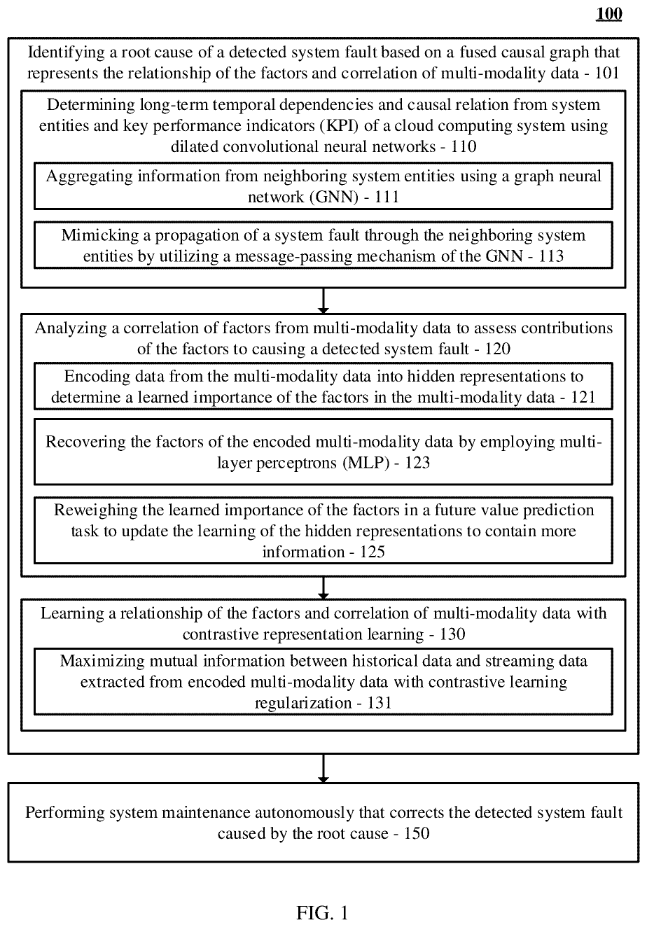

Referring now in detail to the figures in which like numerals represent the same or similar elements and initially to FIG. 1, a high-level overview of the computer-implemented method for online multi-modality root cause analysis is illustratively depicted in accordance with an embodiment of the present invention.

In an embodiment, a root cause of a detected system fault can be identified based on a fused causal graph that represents the relationship of the factors and correlation of multi-modality data by: determining long-term temporal dependencies and causal relation from system entities and key performance indicators (KPI) of a cloud computing system using dilated convolutional neural networks, analyzing a correlation of factors from multi-modality data to assess contributions of the factors to causing a detected system fault, and learning a relationship of the factors and correlation of multi-modality data with contrastive representation learning. System maintenance that corrects the detected system fault caused by the root cause can be performed autonomously.

In block 101, identifying a root cause of a detected system fault based on the relationship of the factors and correlation of multi-modality data.

The system metrics and logs can be collected and preprocessed into multi-variate time series data by utilizing a parser model such as Drain™ parser.

$${X}_{M} = \{ {X}_{M}^{0} , {X}_{M}^{1} , … , {X}_{M}^{T} \}$$

represents T+1 multi-variate time series data for entity metrics. Here,

$${X}_{M}^{0}$$

is the historical metric data, and

$${X}_{M}^{i} ,$$

i∈[1, . . . , T], is the i th batch for the metric data, with T₁ denoting the length of historical metric data, T₁ the length of each batch, n−1 the number of system entities, and d_{M} the number of different system metric features. Similarly,

$${X}_{L} = \{ {X}_{L}^{0} , {X}_{L}^{1} , … , {X}_{L}^{T} \}$$

represents T+1 multi-variate time series data for system logs.

$${X}_{L}^{0}$$

is the historical log data, and

$${X}_{L}^{i} ,$$

i∈[1, . . . , T], is the i th batch for system logs, where d_{L} is the number of different log attributes/features. The system KPI is denoted as y={y⁰, y¹, . . . , y^{T}}, with y⁰ and yⁱ, i∈[1, . . . , T], representing KPI data with lengths T₁ and T₂, respectively.

The propagation of malfunction effects from the root cause to adjacent entities implies that the immediate neighbors of system KPIs may not necessarily be the root causes themselves. To identify the root cause, the transition probability matrix can be derived based on a fused causal graph G and then utilize a random walk with restart method to simulate the spread patterns of malfunctions as follows:

$${P}_{ij} = \frac{β {A}_{j , i}}{{\sum }_{k = 1}^{n} {A}_{k , i}} , \qquad ( 1 )$$

where the transition probability matrix P is the normalized adjacency matrix signified by the coefficient β∈[0,1]. During the visiting exploration process, the KPI node can be restarted to revisit other system entities with the probability c∈[0,1]. The equation for the random walk with restart is formulated by:

$${r}_{t + 1} = ( 1 - c ) {P}_{{r}_{t} + {cr}_{0}} , \qquad ( 2 )$$

where rₜ represents the jumping probability at the t th step, r0 denotes the initial starting probability, and c∈[0,1] stands for the restart probability.

Upon convergence of the jumping probability rₜ, the probability scores of the nodes are employed to rank the system entities and the top k entities are selected as the most probable root causes for system failure.

Stopping Criterion. As the number of new data batches increases, the identified causal structure and its associated root cause list may gradually converge. The causal structure with the associated root cause list can be employed as indicators for automatic termination of the online RCA process. The rank-biased overlap metric (RBO) can be used to measure the similarity between two root cause lists, effectively capturing the evolving trend of root cause rankings. Given the rank lists from the previous and current batches, denoted as Rₜ₋₁ and Rₜ respectively, the similarity between these lists can be quantified as follows:

$$γ = RBO ( {R}_{t - 1} , {R}_{t} ) \qquad ( 3 )$$

where γ∈[0,1]. A higher value of γ indicates a greater similarity between the two root cause lists.

Referring now to how the relationship of the factors and correlation of multi-modality data are determined by the present embodiments.

In block 110, long-term temporal dependencies and causal relation from system entities and key performance indicators (KPI) of a cloud computing system can be determined using dilated convolutional neural networks (DCNN).

To determine the long-term temporal dependencies and causal relation of system entities and KPI, a causal graph G={V,A} can be constructed. V represents the set of vertices, A∈ [symbol] denotes the adjacency matrix, and n is the total number of entities plus the system KPI. To generate the causal graph, the KPI can be replicated d_{M} times to match the number of metrics and concatenate the system metric (M) time-series data and KPI, yielding

$${\hat{X}}_{M}^{0}$$

∈ [symbol] and

$${\hat{X}}_{M}^{i}$$

∈ [symbol] . Similarly, the system log(L) time-series data and KPI can be combined, denoted as

$${\hat{X}}_{L}^{0}$$

∈ [symbol] and \hat{X}_{L}ⁱ∈ [symbol] . To detect system failures online, a Multivariate Singular Spectrum Analysis (MSSA) model can be utilized identify the triggers for the root cause analysis process.

In another embodiment, trigger points can be detected to detect system failures online. Trigger points are transitions in system status that signal significant shifts. In root cause analysis, these trigger points can be viewed as triggers or starting points for the investigation process. When a trigger point is detected, it can indicate a system fault or failure which can prompt automatic initiation of root cause analysis that can identify the root cause sooner and mitigate potential system damage or losses. Trigger points can be detected in an incremental manner by detecting the correlation between observations and past observations by transforming the collected logs into correlation matrices. Each observation and trigger points throughout time in a sliding window has an identifiable source (e.g., workload process, physical node, task, etc.) that can be detected through cumulative sum (CUSUM) statistical testing. A causal graph learning model with an encoder-decoder framework can generate the causal graph from the correlation matrices. A long short-term memory network (LSTM) and a variational graph autoencoder (VGAE) can be used as an encoder. A structural vector autoregressive model (SVAR) can be used as a decoder.

Using three-way tensors (e.g., historical metric data

$${\hat{X}}_{M}^{0}$$

historical log data

$${\hat{X}}_{L}^{0}$$

the current batch of metric data

$${\hat{X}}_{M}^{i}$$

and log data

$${\hat{X}}_{L}^{i} ) ,$$

neural networks such as dilated convolution neural networks, long-short term memory (LSTM), and Gated Temporal Convolutional Network (TCN) can be utilized to model the temporal dependency for the historical and current batches of time series for two modalities as follows:

$$g ( x , f ) = x * f = {\sum }_{τ = 0}^{K - 1} f ( τ ) \cdot x ( t - d \times τ ) \qquad ( 4 )$$

$${H}_{v}^{0} = tan h ( g ( {\hat{X}}_{v}^{0} , f 1 ) ) ⊙ σ 1 ( g ( {\hat{X}}_{v}^{0} , f 2 ) ) \qquad ( 5 )$$

$${H}_{v}^{i} = tan h ( g ( {\hat{X}}_{v}^{i} , f 3 ) ) ⊙ σ 1 ( g ( {\hat{X}}_{v}^{i} , f 4 ) ) \qquad ( 6 )$$

$${\hat{O}}_{v}^{0} = M F L ( {H}_{v}^{0} ) , {\hat{O}}_{v}^{i} = M F L ( {H}_{v}^{i} ) \qquad ( 7 )$$

where ƒ∈ [symbol] represents the 1-D kernel, d is the dilation factor controlling the skipping distance, ⊙ denotes the Hadamard product,

$$v ∈ \{ M , L \} , σ ( x ) = \frac{1}{( 1 + {e}^{- x} )}$$

is the sigmoid function, and

$$tan h ( x ) = \frac{{e}^{x} - {e}^{- x}}{{e}^{x} + {e}^{- x}}$$

is the tanh function. f1, f2, f3, and f4 are 1-D kernels of the dilated convolution neural networks.

$${H}_{v}^{0}$$

∈ [symbol] and

$${H}_{v}^{i}$$

∈ [symbol] represent the historical time series and the i th batch of streaming time series for the modality v, respectively. T₃ and T₄ are the output dimensions of the dilated convolution neural networks. Additionally, MFL(⋅) denotes the representation learning with multifactor attention module of the dilated convolution neural networks to encode the correlation of different metrics into the representations

$${\hat{O}}_{v}^{0}$$

∈ [symbol] and

$${\hat{O}}_{v}^{i}$$

∈ [symbol] .

Dilated convolutional neural networks are a type of convolutional neural networks that employs dilated convolutions which can “inflate” a kernel by inserting holes between kernel elements which can be measured with a dilation rate parameter.

In blocks 111 and 113, to learn the causal relation, information from neighbors can be aggregated via a graph neural network (GNN) (e.g., GraphSAGE) and fault propagation can be mimicked through a message-passing mechanism of the GNN:

$${\tilde{X}}_{v}^{0} = {σ}_{2} ( {A}_{old} ( {\hat{O}}_{v}^{0} ⊕ {N}_{v}^{0} ) {W}^{1} ) , \qquad ( 8 )$$

$${\tilde{X}}_{v}^{i} = {σ}_{2} ( ( {A}_{old} + Δ {A}_{ν} ) ( {\hat{O}}_{v}^{i} ⊕ {N}_{v}^{i} ) {W}^{2} ) , \qquad ( 9 )$$

where

$${N}_{v}^{0} [ j ] = \frac{1}{\vert {N}_{j} \vert} {\sum }_{k ∈ {N}_{j}} {\hat{O}}_{v}^{0} [ k ] , {N}_{v}^{1} [ j ] = \frac{1}{\vert {N}_{j} \vert} {\sum }_{k ∈ {N}_{j}} {\hat{O}}_{v}^{i} [ k ] ,$$

W¹ and W² are weight matrices, ⊕ denotes concatenation, Nⱼ represents node entity j's neighbors, Nᵥⁱ aggregates neighbor information, A_{old} is the previous batch's learned causal graph, and ΔAᵥ∈ [symbol] is a learnable adjacency matrix. Unlike A_{old}, ΔAᵥ captures unique patterns in the current streaming data batch.

$${\tilde{X}}_{v}^{0} ( {\tilde{X}}_{v}^{i} )$$

predicts future values based on previous lagged data

$${\hat{X}}_{v}^{0} ( {\hat{X}}_{v}^{i} ) ,$$

leveraging temporal dependencies captured by dilated convolutional neural networks.

The forecasting errors can then be minimized for training the DCNN:

$${ℒ}_{temporal} = \frac{1}{n ( {d}_{L} + {d}_{M} )} {\sum }_{v} {\sum }_{j = 1}^{n} {\sum }_{k = 1}^{{d}_{ν}} [ {\vert \vert {\hat{X}}_{v}^{0} [ j , k ] - {\tilde{X}}_{v}^{0} [ j , k ] \vert \vert}^{2} + {\vert \vert {\hat{X}}_{v}^{i} [ j , k ] - {\tilde{X}}_{v}^{i} [ j , k ] \vert \vert}^{2} ] \qquad ( 10 )$$

After minimizing the forecasting errors and utilizing the message-passing mechanism of the GNN, a causality can be encoded in the learned adjacency matrix Ã=A_{old}+ΔAᵥ, such as X→y, where X is a potential root cause and y is a Key Performance Indicator (KPI). Additionally, to ensure that Ã is acyclic, the trace exponential function h(Ã)=(tr(e^{Ã⊙Ã})−n)=0 can be added as a regularization term, where ⊙ denotes the Hadamard product of two matrices.

In block 120, a correlation of factors from multi-modality data can be analyzed to assess the contribution of the factors to causing a detected system fault.

Existing RCA methods analyze abnormal patterns from each factor (e.g., metric or log) individually, neglecting potential relationships among them. However, the importance of factors can vary depending on the abnormal pattern. To bridge this gap, a correlation of different factors from two modalities and the contribution of each factor can be determined using causal structure learning with the attention mechanism.

In block 121, data from the multi-modality data can be encoded into hidden representations to determine a learned importance of the factors in the multi-modality data. Given two representations

$${H}_{L}^{0} and {H}_{M}^{0}$$

in Eq. (5), the multi-factor similarity matrix

$${C}_{j}^{0}$$

∈ [symbol] can be computed for historical representation of the j th system entity to capture the correlation of different modalities and the relationship among multiple metrics and log indicators as follows:

$${C}_{j}^{0} = tan h ( {H}_{M}^{0} [ j ] {W}^{3} {( {H}_{L}^{0} [ j ] )}^{T} ) \qquad ( 11 )$$

where W³∈ [symbol] is a weight matrix and

$${H}_{M}^{0} [ j ]$$

denotes the historical representation of the j-th system entity for modality metric M,

$${H}_{L}^{0} [ j ]$$

denotes the historical representation of the j-th system entity for modality log L. The equations related to the i-th batch of streaming data can be skipped, unless their computation differs from historical data. This matrix measures the similarities between modalities and among multiple factors.

By leveraging this similarity matrix, the information from both modalities can be encoded, through an encoder such as a multi-layer perceptron, in the hidden representation

$${H}_{v}^{0} ,$$

v∈{M,L} and the importance of each factor across both modalities can be assessed, formulated as:

$${Z}_{L}^{0} [ j ] = tan h ( {H}_{L}^{0} [ j ] {W}^{4} + {H}_{M}^{0} [ j ] {C}_{j}^{0} {W}^{5} ) \qquad ( 12 )$$

$${Z}_{M}^{0} [ j ] = tan h ( {H}_{M}^{0} [ j ] {W}^{5} + {H}_{L}^{0} [ j ] {( {C}_{j}^{0} )}^{T} {W}^{4} ) \qquad ( 13 )$$

$${a}_{L}^{0} [ j ] = softmax ( {w}^{6} {Z}_{L}^{0} [ j ] ) \qquad ( 14 )$$

$${a}_{M}^{0} [ j ] = softmax ( {w}^{7} {Z}_{M}^{0} [ j ] ) \qquad ( 15 )$$

where W⁴∈ [symbol] and W⁵∈ [symbol] are two weight matrices and w⁶∈ [symbol] and w⁷∈ [symbol] are two weight vectors,

$${Z}_{L}^{0} [ j ] and {Z}_{M}^{0} [ j ]$$

are the encoded information for log and metric modalities respectively, and

$${a}_{L}^{0} [ j ] and {a}_{M}^{0} [ j ]$$

measure the importance of each factor by encoding information from both modalities, capturing rich relationships for multi-modality and multi-dimensional data. Using these attention vectors, information learned from multiple factors of two modalities can be encoded into the weighted representation

$${\hat{H}}_{v}^{0}$$

∈ [symbol] by:

$${\hat{H}}_{v}^{0} [ j ] = {\sum }_{k = 1}^{{d}_{ν}} {a}_{v}^{0} [ i , k ] \cdot {H}_{v}^{0} [ j , k ] \qquad ( 16 )$$

In block 123, after encoding the relationship among different factors and two modalities into

$${\hat{H}}_{v}^{0} and {\hat{H}}_{v}^{i} ,$$

the factors of two modalities can be recovered by:

$${O}_{v}^{0} = {MLP}^{0} ( {\hat{H}}_{v}^{0} ) , {O}_{v}^{i} = {MLP}^{1} ( {\hat{H}}_{v}^{1} ) \qquad ( 17 )$$

where MLP⁰ and MLP¹ are two multi-layer perceptrons (MLP) to recover the metrics,

$${O}_{v}^{0}$$

∈ [symbol] and

$${O}_{v}^{i}$$

∈ [symbol] . Eqs. (11)-(17) can be combined to derive MFL(⋅) in Eq. (7).

In block 125, after assessing the contribution of each factor to the causal structure learning, aᵥ[j,k] can be used reweigh the importance of different factors in the future value prediction task in Eq. (14)-(15) and further encourage that the representation

$${\hat{H}}_{v}^{0} and {\hat{H}}_{v}^{i}$$

contain more information for the factor with a larger weight aᵥ[j,k]. Therefore, Eq. (10) can be updated as follows:

$${L}_{temporal} = \frac{1}{n ( {d}_{L} + {d}_{M} )} {\sum }_{v} {\sum }_{j = 1}^{n} {\sum }_{k = 1}^{{d}_{v}} [ \text{} {a}_{v}^{0} [ j , k ] {‖ {\hat{X}}_{v}^{0} [ j , k ] - {\tilde{X}}_{v}^{0} [ j , k ] ‖}^{2} + {a}_{v}^{i} [ j , k ] {‖ {\hat{X}}_{v}^{i} [ j , k ] - {\tilde{X}}_{v}^{i} [ j , k ] ‖}^{2} ] \qquad ( 18 )$$

In block 130, a relationship of the factors and correlation of multi-modality data can be learned with contrastive representation learning.

The relatedness between two modalities can be maximized via contrastive mutual information maximization (MIM) to address the issues of multi-modality training.

In block 131, given the representations of historical data

$${\hat{H}}_{v}^{0}$$

and streaming data

$${\hat{H}}_{v}^{i}$$

extracted from both metric and log data, the mutual information between the two modalities can be maximized:

$${ℒ}_{MI} = {I}_{ϕ} ( {\hat{H}}_{M}^{0} , {\hat{H}}_{L}^{0} ) + {I}_{ϕ} ( {\hat{H}}_{M}^{i} , {\hat{H}}_{L}^{i} ) \qquad ( 19 )$$

where I_{ϕ} is the mutual information parameterized by a neural network ϕ. Following information noise-contrastive estimation (InfoNCE) style contrastive loss, the mutual information with its lower bound can be approximated as follows:

$${I}_{ϕ} ( {\hat{H}}_{M}^{0} , {\hat{H}}_{L}^{0} ) : = \frac{1}{n} {\sum }_{j = 1}^{n} log \frac{sim ( ϕ ( {\hat{H}}_{M}^{0} [ j ] ) , ϕ ( {\hat{H}}_{L}^{0} [ j ] ) )}{{\sum }_{k} sim ( ϕ ( {\hat{H}}_{M}^{0} [ j ] ) , ϕ ( {\hat{H}}_{L}^{0} [ k ] ) )} \qquad ( 20 )$$

where

$$sim ( a , b ) = exp ( \frac{a {b}^{T}}{\vert a \vert \vert b \vert} )$$

is the exponential of cosine similarity measurement between two entity representations a and b. To generate the causal graph for the current batch of data, simple addition may not work because it may result in dense and cyclical graphs. This issue might even exacerbate in the low-quality modality scenario, as one modality might convey more important information than others. The low-quality modality usually obscures the patterns for causal graph learning if both modalities are treated with equal importance.

To address this issue, the importance of two modalities with the correlation of multiple metrics can be measured. Based on the similarity map for the current batch (i.e.,

$${C}_{j}^{i} ) ,$$

the importance of each modality can be measured and fuse two causal graphs:

$${S}_{M} = \frac{{\sum }_{j = 1}^{n} {\sum }_{l = 1}^{{d}_{M}} exp ( {\sum }_{k = 1}^{{d}_{L}} {C}_{j}^{i} [ l , k ] )}{\begin{matrix}{\sum }_{j = 1}^{n} {\sum }_{l = 1}^{{d}_{M}} exp ( {\sum }_{k = 1}^{{d}_{L}} {C}_{j}^{i} [ l , k ] ) + \\ {\sum }_{j = 1}^{n} {\sum }_{l = 1}^{{d}_{L}} exp ( {\sum }_{k = 1}^{{d}_{M}} {C}_{j}^{i} [ l , k ] )\end{matrix}} \qquad ( 21 )$$

$${A}_{fused} = ( 1 - {S}_{M} ) \cdot ( {A}_{old} + Δ {A}_{v} ) + {S}_{M} \cdot ( {A}_{old} + Δ {A}_{v} ) . \qquad ( 22 )$$

The final objective function can be defined as:

$${ℒ}_{spaτse} = {‖ Δ {A}_{L} ‖}_{1} + {‖ Δ {A}_{M} ‖}_{1} \qquad ( 23 )$$

$$ℒ = - {ℒ}_{MI} + {λ}_{1} 1 {ℒ}_{temporal} + {λ}_{2} {ℒ}_{sparse} + {λ}_{3} h ( {A}_{fused} ) \qquad ( 24 )$$

where ∥⋅∥₁ is the sparsity constraint imposed on the adjacency matrix and [symbol] ₛₚₐᵣₛₑ aims to ensure that the changes of the edges are expected to be sparse. The trace exponential function h(A)=(tr(e^{A⊙A})−n)=0 holds if and only if A is acyclic, where ⊙ denotes the Hadamard product of two matrices. λ₁, λ₂ and λ₃ are the positive constant hyper-parameters. The final objective function (e.g., eq. (24)) is used to train the DCNN.

In block 150, the cloud system can autonomously perform system maintenance based on the identified root cause from identified system entities to optimize the cloud system with an updated configuration.

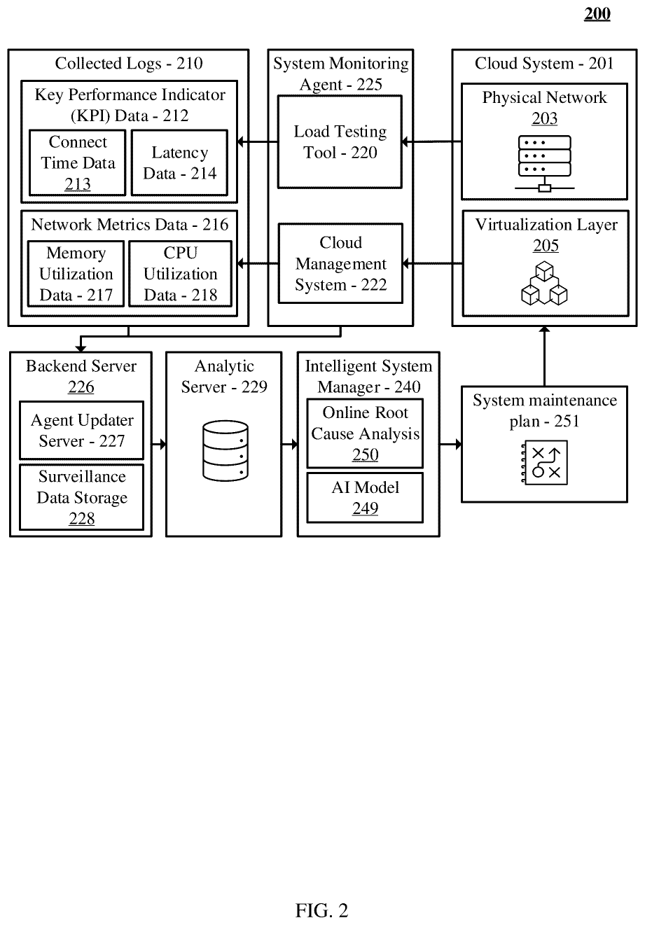

The present embodiments can autonomously perform system maintenance based on a system maintenance plan that can be tailored to correct the detected system fault/failure caused by the identified root cause. For example, if the detected trigger point is related to CPU utilization, the system maintenance plan can include updating the cloud system with more CPU resources, updating the virtualization layer of the cloud system, etc. This is shown in more detail in FIG. 2.

Referring now to FIG. 2, a block diagram showing a cloud intelligent system architecture for online multi-modality root cause analysis, in accordance with an embodiment of the present invention.

The cloud intelligent system architecture 200 can have several components, layers, and functions including a physical network, a virtualization layer, a management layer, and a workloads layer. The physical network 203 can include hardware and software components. Examples of hardware components include: mainframes, RISC (Reduced Instruction Set Computer) architecture-based servers, servers, blade servers, storage devices, and networks and networking components. In some embodiments, software components include network application server software and database software. The virtualization layer 205 provides an abstraction layer from which the following examples of virtual entities may be provided: virtual servers, virtual storage, virtual networks, including virtual private networks, virtual applications, operating systems, and virtual clients.

The management layer can include the system monitoring agent 225, the backend server, and the intelligent system manager 240. The workloads layer can include software and hardware related to end-user functionalities which can include the online root cause analysis module 250 within the intelligent system manager 240 and the analytic server.

In an embodiment, an intelligent system manager 240 can process the identified root cause and create a system maintenance plan 251 for the cloud system 201 to resolve a system issue caused by the identified root cause. The system maintenance plan 251 can include applying system patches to the cloud system 201 to overcome a system vulnerability that can be caused by the identified root cause. The system monitoring agent 225 can then autonomously place the cloud system 201 under system maintenance to install the system patches. The installation of the system patches can be done in the background without interfering with access to the cloud system 201.

In another embodiment, the system maintenance plan 251 can include updating the system configuration of the physical network 203 of the cloud system 201 such as increasing CPU or memory capacity, or blocking anomalous packets from internet protocol (IP) addresses. In another embodiment, the system maintenance plan 251 can include updating the configuration of the virtualization layer 205 of the cloud system 201 such as updating container and node configuration.

In another embodiment, the intelligent system manager 240 can notify a cloud system professional through an alarm module regarding the results of the online root cause analysis.

In another embodiment, the intelligent system manager 240 can output explanations regarding system faults or failure based on the identified root cause. The identified root cause can have identifiable sources and timestamps on which point and batch of processing the trigger point and detected trigger point occurred (e.g., batch processing data). The source identifier, timestamp, batch processing data can be compiled and converted to a complete sentence to produce an explanation of how a system fault or failure occurred due to the detected trigger point. In another embodiment, the conversion to complete sentences can be done by an artificial intelligence model 249.

In another embodiment, the intelligent system manager 240 can perform log analysis and process the logs produced in the cloud system and detect trigger points and root causes of system failures/faults within the cloud through the logs.

In another embodiment, the intelligent system manager 240 can perform risk analysis by analyzing the identified root cause to identify the potential issues and consequences associated with the identified root cause. The identified potential issues can be assessed to evaluate their severity and likelihood of occurrence. The identified potential issues can be ranked based on severity and likelihood of occurrence which can be presented to the cloud system professional to help with their decision making.

In an embodiment, the system monitoring agent 225 can collect data metrics from the cloud system. The collected logs 210 can be time series data that can be streamed directly from the cloud system. There can be two types of collected logs 210: key performance indicator (KPI) data 212 for the physical network 203 of the cloud system, and network metrics data 216 for system entities of the cloud system, which can include running containers and computing nodes including applications of the virtualization layer 205. The collected logs can be sent from the cloud system 201 to a backend server 226 for storage through a network. The collected logs 210 can be sent from the cloud system 201 to an analytics server 229, through a network.

KPI data 212 can include system performance information (e.g. features) of a system entity of the cloud system such as elapsed time, latency, connect time, thread name, throughput etc. The load testing tool can be JMeter®, Locust®, etc. Other load testing tools are contemplated. The KPI data 212 can be formatted in a chronological order having the data related to time to be included in the beginning. For example, the format can be “timestamp, elapsed, idle time, connect time, etc.”

The latency data 214 and connect time data 213 can be the primary performance KPIs of the whole cloud system. The latency data 214 measures the latency from just before sending the request from a system entity, to just after a first chunk of the response has been received by another system entity. Connect time data 213 measures the time it took to establish the connection between at least two system entities, including a secure sockets layer (SSL) handshake.

Both latency data 214 and connect time data 213 are time series data, which can indicate the system status and directly reflect the quality of service of system entities. For example, the quality of service of system entities can show whether the whole system has some failure events happening or not, because system failure can result in the latency data 214 or connect time data 213 significantly increasing.

The cloud management system 222 can collect network metrics data 216. The cloud management system 222 can be Openshift®, Prometheus™, etc. Other cloud management systems are contemplated. The network metrics data 216 can include a number of metrics which indicate the status of a system entity of the cloud system. The network metrics data 216 (e.g. features) can be the central processing unit (CPU) utilization or saturation data 218, memory utilization or saturation 217, or disk input/output (I/O) utilization.

The backend server 226 and analytics server 226 can include hardware and software components. Examples of hardware components include: mainframes, RISC architecture-based servers, servers, blade servers, storage devices, and networks and networking components. In some embodiments, software components include network application server software and database software.

In an embodiment, the intelligent system manager 240 can include online root cause analysis module 250. Using online root cause analysis module 250, the intelligent system manager 240 can generate a system maintenance plan 251 that corrects issues caused by the detected root cause.

The intelligent system manager 240 can include an AI model 249 to learn the identified root cause and predict the system vulnerabilities or issues that may be caused by the identified root cause. The intelligent system manager 240 can employ the AI model 249 to also predict appropriate fixes to the predicted system vulnerabilities and issues that may be caused by the identified root cause. Due to the streaming nature of cloud systems, the AI model 249 can be continuously trained with newly collected logs 210 from the cloud system to fine-tune the predictions of the AI model 249. The AI model 249 can include autoencoders, gaussian mixture models, graph neural networks, Bayesian networks, etc. Other artificial intelligence frameworks are contemplated.

The intelligent system manager 240 can be included in an analytic server 229.

The backend server 226 can include an agent updater server 227 and the surveillance data storage 228. The agent updater server 227 can ensure that the system monitoring agent 225 is updated with the latest version of firmware and software updates that are compatible with the current cloud system 201 infrastructure. The backend server 229 can perform data pre-processing of the collected logs 210 that has been stored in surveillance data storage 228 within the backend server 226. The data pre-processing process can ensure that the collected logs 210 is clean, consistent, and relevant. As such, the data pre-processing process can include data formatting, data quality assurance, data normalization, data integration, data cleaning, etc.

The system monitoring agent 225 can monitor the cloud system 201 by installing a load testing tool 220 and a cloud management system 222. The load testing tool 220 can collect the KPI Data 212 that can include connect time data 213 and latency data 214. The cloud management system 222 can collect network metrics data 216 that can include a number of metrics which indicates the status of system entities (e.g., computing nodes, containers) of the cloud system such as memory utilization data 217 and CPU utilization data 218.

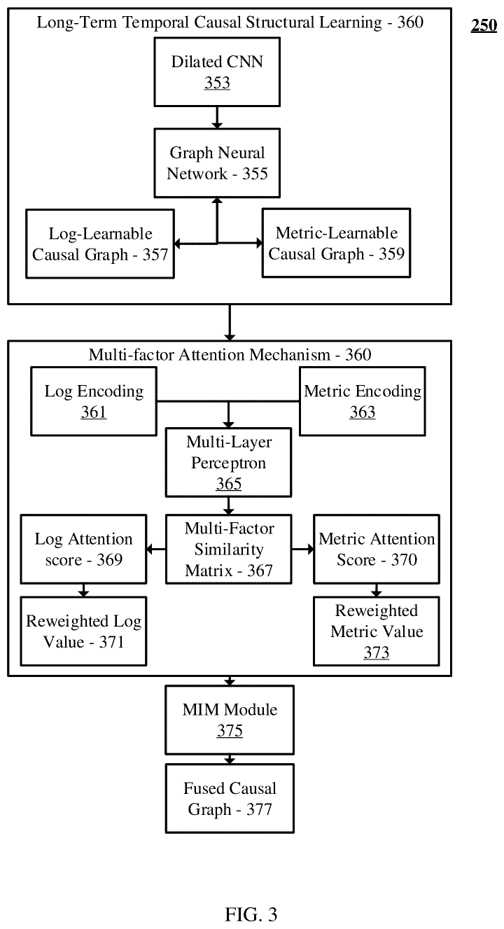

Referring now to FIG. 3, a block diagram showing software and hardware components of the online root causes analysis module, in accordance with an embodiment of the present invention.

Online root cause analysis module 250 can include at least three main sub-modules long-term temporal causal structural learning (LTCS) module 360, multi-factor attention mechanism (MFAM) module 360, and the contrastive mutual information maximization (MIM) module 375. The online root cause analysis module 250 uses the network metrics data 216 and the KPI data 212 to generate a fused causal graph 377 that identifies the root cause of a system failure.

The LTCS module 360 can train a dilated CNN 353 and a graph neural network 355 to generate log-learnable causal graph 357 and metric-learnable causal graph 359. The log-learnable causal graph 357 and metric-learnable causal graph 359 can be processed by the M FAM module 360 to generate log encoding 361 and metric encoding 363. The log encoding 361 and metric encoding 363 can be utilized to train a multi-layer perceptron 365 to generate a multifactor similarity matrix 367 which can include a metric attention score 370 and a log attention score 369. The M FAM module 360 can be utilized iteratively to generate reweighted log value 371 and reweighted metric value 373 from the multi-factor similarity matrix 367. The log-learnable causal graph 357 can be recreated based on the reweighted log value 371 and the metric learnable causal graph 359 can be recreated based on the reweighted metric value 373. The recreated log-learnable causal graph 357 and the metric learnable causal graph 359 can be processed by the MIM module 375 to generate the fused causal graph 377 which can include the list of system entities that likely produced the system failure/fault.

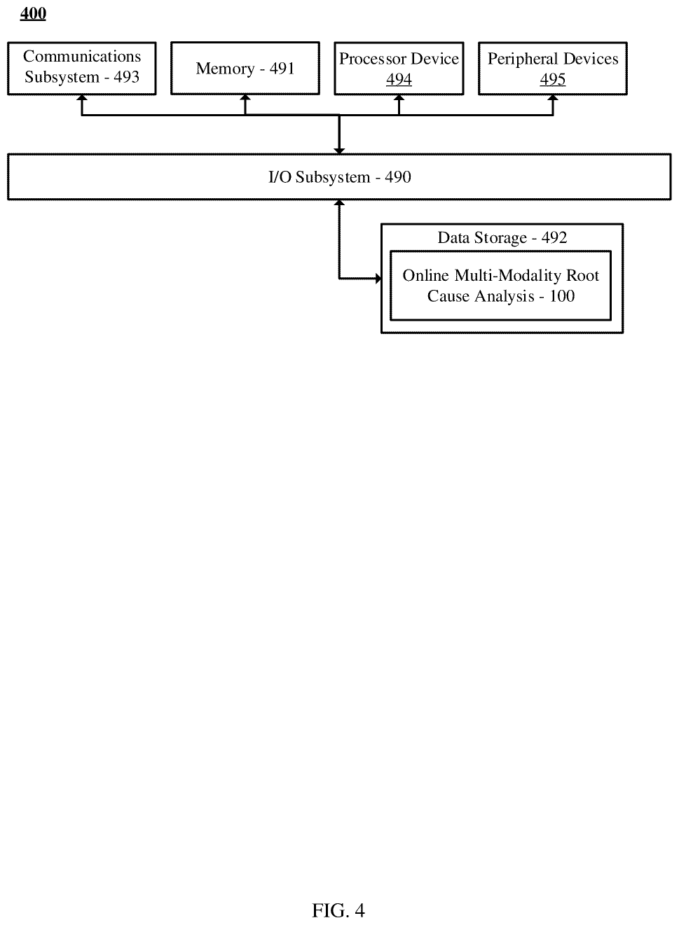

Referring now to FIG. 4, a block diagram showing a computing system for online multi-modality root cause analysis, in accordance with an embodiment of the present invention.

The computing device 400 illustratively includes the processor device 494, an input/output (I/O) subsystem 490, a memory 491, a data storage device 492, and a communication subsystem 493, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 491, or portions thereof, may be incorporated in the processor device 494 in some embodiments.

The processor device 494 may be embodied as any type of processor capable of performing the functions described herein. The processor device 494 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 491 may be embodied as any type of volatile or non-volatile memory or data storage capable of performing the functions described herein. In operation, the memory 491 may store various data and software employed during operation of the computing device 400, such as operating systems, applications, programs, libraries, and drivers. The memory 491 is communicatively coupled to the processor device 494 via the I/O subsystem 490, which may be embodied as circuitry and/or components to facilitate input/output operations with the processor device 494, the memory 491, and other components of the computing device 400. For example, the I/O subsystem 490 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 490 may form a portion of a system-on-a-chip (SOC) and be incorporated, along with the processor device 494, the memory 491, and other components of the computing device 400, on a single integrated circuit chip.

The data storage device 492 may be embodied as any type of device or devices configured for short-term or long-term storage of data such as, for example, memory devices and circuits, memory cards, hard disk drives, solid state drives, or other data storage devices. The data storage device 492 can store program code for online multi-modality root cause analysis 100. Any or all of these program code blocks may be included in a given computing system.

The communication subsystem 493 of the computing device 400 may be embodied as any network interface controller or other communication circuit, device, or collection thereof, capable of enabling communications between the computing device 400 and other remote devices over a network. The communication subsystem 493 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 495. The peripheral devices 495 may include any number of additional input/output devices, interface devices, and/or other peripheral devices. For example, in some embodiments, the peripheral devices 495 may include a display, touch screen, graphics circuitry, keyboard, mouse, speaker system, microphone, network interface, and/or other input/output devices, interface devices, GPS, camera, and/or other peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 400 are readily contemplated by one of ordinary skill in the art given the teachings of the present invention provided herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that can perform one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

The cloud system can have at least the following service models: software as a service (Saas), platform as a service (PaaS), or Infrastructure as a service (IaaS). Other service models are contemplated. The cloud system can have at least the following deployment models: private cloud, community cloud, public cloud or hybrid cloud. Other deployment models are contemplated.

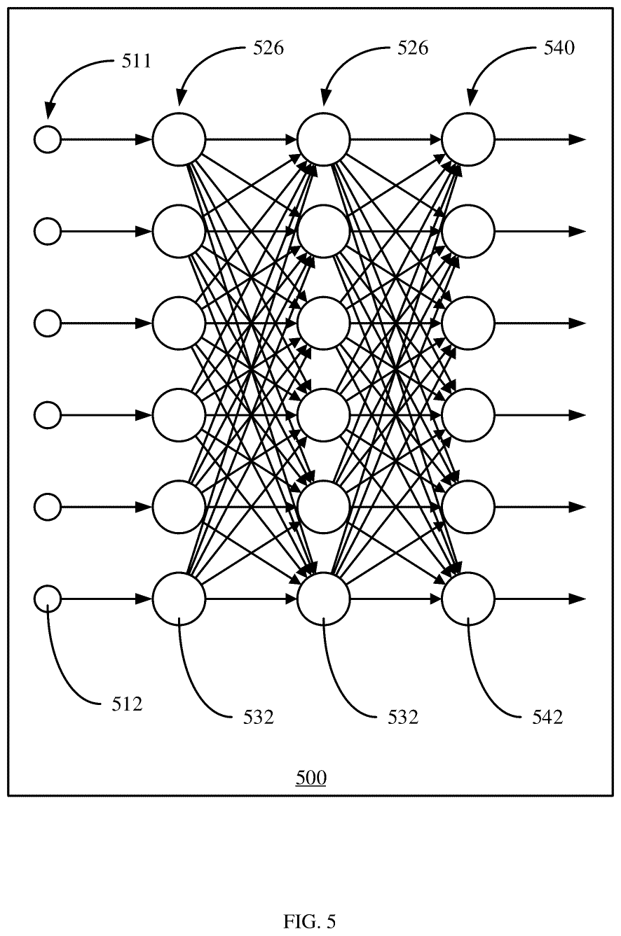

Referring now to FIG. 5, a block diagram showing a structure of deep neural networks for online multi-modality root cause analysis, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x,y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source neurons 512, one or more computation layer(s) 526 having one or more computation neurons 532, and an output layer 540, where there is a single output neuron 542 for each possible category into which the input example could be classified. An input layer 511 can have a number of source neurons 512 equal to the number of data values 512 in the input data 511. The computation neurons 532 in the computation layer(s) 526 can also be referred to as hidden layers, because they are between the source neurons 512 and output neuron(s) 542 and are not directly observed. Each neuron 532, 542 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons 532 in the one or more computation (hidden) layer(s) 526 perform a nonlinear transformation on the input data 512 that generates a feature space. The classes or categories may be more easily separated in the feature space than in the original data space.

In an embodiment, the computation layers 526 of the Dilated CNN 353 can learn the relationships between the log and metric data and learn the long-term temporal and causal dependencies between them. The output layers 542 of the Dilated CNN 353 can then output a log-learnable causal graph 357 and metric-learnable causal graph 359. In an embodiment, the computation layers 526 of the multi-layer perceptron 365 can learn the similarity between the log and metric data and encode the log and metric data into log encoding 361 and metric encoding 363. The output layers 542 of the multi-layer perceptron 365 can then output a reweighted log value 371 and a reweighted metric value 373 that can be used to generated new log-learnable causal graph 357 and metric-learnable causal graph 359. In another embodiment, the computation layers 526 of the Dilated CNN 353 can learn the importance and correlation between the new log-learnable causal graph 357 and metric-learnable causal graph 359 through the MIM Module 375. The output layers 542 of the Dilated CNN 353 can then output a fused causal graph 377.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for online multi-modality root cause analysis, comprising:
identifying a root cause of a detected system fault based on a fused causal graph that represents a relationship of factors and correlation of multi-modality data by:
determining long-term temporal dependencies and causal relation from system entities and key performance indicators (KPI) of a cloud computing system using dilated convolutional neural networks (DCNN);
analyzing a correlation of factors from multi-modality data to assess contributions of the factors to causing a detected system fault;
learning, with the DCNN, a relationship of the factors and correlation of multi-modality data with contrastive representation learning; and
performing system maintenance autonomously that corrects the detected system fault caused by the root cause.

2. The computer-implemented method of claim 1, wherein determining the long-term temporal dependencies further comprises aggregating information from neighboring system entities using a graph neural network (GNN).

3. The computer-implemented method of claim 2, wherein determining the long-term temporal dependencies further comprises mimicking a propagation of a system fault through the neighboring system entities by utilizing a message-passing mechanism of the GNN.

4. The computer-implemented method of claim 1, wherein analyzing the correlation of factors further comprises encoding data from the multi-modality data into hidden representations to determine a learned importance of the factors in the multi-modality data.

5. The computer-implemented method of claim 4, wherein analyzing the correlation of factors further comprises reweighing the learned importance of the factors in a future value prediction task to update the learning of the hidden representations to contain more information.

6. The computer-implemented method of claim 1, wherein learning the relationship of the factors further comprises maximizing mutual information between historical data and streaming data extracted from the multi-modality data with contrastive learning regularization.

7. The computer-implemented method of claim 6, wherein learning the relationship of the factors further comprises recovering the factors of encoded multi-modality data by employing multi-layer perceptrons (MLP).

8. A system for online multi-modality root cause analysis, comprising:
a memory device; and
one or more processor devices operatively coupled with the memory device to:
identify a root cause of a detected system fault based on a fused causal graph that represents a relationship of factors and correlation of multi-modality data by:
determining long-term temporal dependencies and causal relation from system entities and key performance indicators (KPI) of a cloud computing system using dilated convolutional neural networks;
analyzing a correlation of factors from multi-modality data to assess contributions of the factors to causing a detected system fault;
learning a relationship of the factors and correlation of multi-modality data with contrastive representation learning; and
perform system maintenance autonomously that corrects the detected system fault caused by the root cause.

9. The system of claim 8, wherein determining the long-term temporal dependencies further comprises to aggregate information from neighboring system entities using a graph neural network (GNN).

10. The system of claim 9, wherein determining the long-term temporal dependencies further comprises to mimic a propagation of a system fault through the neighboring system entities by utilizing a message-passing mechanism of the GNN.

11. The system of claim 8, wherein analyzing the correlation of factors further comprises encoding data from the multi-modality data into hidden representations to determine a learned importance of the factors in the multi-modality data.

12. The system of claim 11, wherein analyzing the correlation of factors further comprises reweighing the learned importance of the factors in a future value prediction task to update the learning of the hidden representations to contain more information.

13. The system of claim 8, wherein learning the relationship of the factors further comprises to maximize mutual information between historical data and streaming data extracted from the multi-modality data with contrastive learning regularization.

14. The system of claim 13, wherein learning the relationship of the factors further comprises to recover the factors of encoded multi-modality data by employing multi-layer perceptrons (MLP).

15. A non-transitory computer program product comprising a computer-readable storage medium including program code for online multi-modality root cause analysis, wherein the program code when executed on a computer causes the computer to:
identify a root cause of a detected system fault based on a fused causal graph that represents a relationship of factors and correlation of multi-modality data by:
determining long-term temporal dependencies and causal relation from system entities and key performance indicators (KPI) of a cloud computing system using dilated convolutional neural networks;
analyzing a correlation of factors from multi-modality data to assess contributions of the factors to causing a detected system fault;
learning a relationship of the factors and correlation of multi-modality data with contrastive representation learning; and
perform system maintenance autonomously that corrects the detected system fault caused by the root cause.

16. The non-transitory computer program product of claim 15, wherein determining the long-term temporal dependencies further comprises to aggregate information from neighboring system entities using a graph neural network (GNN).

17. The non-transitory computer program product of claim 16, wherein determining the long-term temporal dependencies further comprises to mimic a propagation of a system fault through the neighboring system entities by utilizing a message-passing mechanism of the GNN.

18. The non-transitory computer program product of claim 15, wherein analyzing the correlation of factors further comprises encoding data from the multi-modality data into hidden representations to determine a learned importance of the factors in the multi-modality data.

19. The non-transitory computer program product of claim 18, wherein analyzing the correlation of factors further comprises reweighing the learned importance of the factors in a future value prediction task to update the learning of the hidden representations to contain more information.

20. The non-transitory computer program product of claim 15, wherein learning the relationship of the factors further comprises to maximize mutual information between historical data and streaming data extracted from the multi-modality data with contrastive learning regularization.
